(19) United States
(12) Patent Application Publication
(10) Pub. No.: US 2008/0122222 A1
(43) Pub. Date: May 29, 2008

(54) Crimp-on transition fitting

(75) Inventor: Scott Steven Sheppard, Brutus, MI (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: H & H Tube & Manufacturing Co.

(21) Appl. No.: 11/605,742

(22) Filed: Nov. 29, 2006

(51) Int. Cl. F16L 33/00

(52) U.S. Cl. 285/256; 137/561 R; 29/428

(57) ABSTRACT

An example transition fitting includes a fitting body have a first shoulder, a second shoulder and a compression region extending radially inwardly from the first shoulder and the second shoulder. A fluid conduit is attached to the fitting body about the compression region. The fluid conduit is deformed radially inwardly from the first shoulder and the second shoulder to secure the fitting body in an axial direction along a longitudinal centerline axis of the fitting body. The fitting body is rotatable along a longitudinal centerline axis of the fitting body.

### BACKGROUND OF THE INVENTION

This invention generally relates to a fluid conduit system, and more particularly to a transition fitting for use within the fluid conduit system.

Fluid conduit systems are known which require transitions between tubular members of different materials. For example, hydronic radiant heating systems typically include copper tubing which delivers a fluid, such as water, from a water source, such as a boiler, to a manifold circuit. The manifold circuit includes a multitude of copper riser tubes for distributing the water. Plastic tubular members, such as cross-linked polyethylene (PEX) tubing, are connected to the riser tubes to distribute the water to various locations, such as throughout a building or home.

A transition fitting is commonly used to provide a flow path connection between the copper riser tubes and the PEX tubing. Several ASTM standards specify the industry standard for providing the connection between the PEX tubing and the transition fitting. ASTM standard F1807, for example, requires that the transition fitting be inserted into the tubing, and a copper crimp ring be crimped or swaged about the tubing. The crimping operation compresses the crimp ring with a crimping tool, thereby forcing the PEX tubing material into annular spaces between external grooves formed on the transition fitting.

Separate methods are utilized to secure the copper riser tube to the transition fitting. A first method involves soldering the transition fitting to the copper riser tube. A second method involves crimping the copper riser tube over an o-ring received on a groove of the transition fitting. Disadvantageously, both of these methods require additional tools and skills to secure the transition fitting to the copper riser tubes. That is, the crimping tool utilized to provide the connection between the PEX tubing and the transition fitting is not also useable to connect the transition fitting to the riser tubes.

In addition, auxiliary fittings, such as valves, elbows and the like, are often required to distribute the tubing where sharp angles are desired or spacing is limited. Therefore, a plumber is required to stock numerous different transition fittings to provide the necessary connections that may be required during installation. Additionally, each different transition fitting may require a separate tool for attaching the numerous auxiliary fittings to the transition fitting. This may be inconvenient, expensive and undesirable from an installation efficiency standpoint.

Accordingly, it is desirable to provide a crimp-on transition fitting that reduces the expense and complexity of known fluid conduit system joining processes and provides flexibility during the installation process.

### SUMMARY OF THE INVENTION

An example transition fitting includes a fitting body having a first shoulder, a second shoulder and a compression region extending radially inwardly from the first shoulder and the second shoulder. A fluid conduit is attached to the fitting body about the compression region. The fluid conduit is deformed radially inwardly from the first shoulder and the second shoulder to secure the fitting body in an axial direction along a longitudinal centerline axis of the fitting body. The fitting body is rotatable along a longitudinal centerline axis of the fitting body.

An example fluid conduit system includes a fluid main, a manifold circuit in communication with the fluid main and having a riser tube extending therefrom, a fluid conduit in communication with the riser tube, and a transition fitting between the riser tube and the fluid conduit. The riser tube and the fluid conduit are attached to opposite ends of the transition fitting. The transition fitting is circumferentially rotatable about a longitudinal centerline axis of the transition fitting.

An example method of providing a fluid conduit system includes connecting a first fluid conduit to a transition fitting, connecting a second fluid conduit to a transition fitting, and rotating the transition fitting subsequent to connecting the first fluid conduit and the second fluid conduit to position one of the first fluid conduit and the second fluid conduit at a desired orientation.

The various features and advantages of this invention will become apparent to those skilled in the art from the following detailed description. The drawings that accompany the detailed description can be briefly described as follows.

### BRIEF DESCRIPTION OF THE DRAWINGS

FIG. 1 illustrates an example fluid conduit system;

FIG. 2 illustrates an example transition fitting for use within a fluid conduit system;

FIG. 3 illustrates an exploded view of a section of the transition fitting illustrated in FIG. 2;

FIG. 4 illustrates a cross-sectional view of the transition fitting;

FIG. 5 illustrates a cross-sectional view of a crimped connection between the example transition fitting and a fluid conduit;

FIG. 6 illustrates an example method of providing a fluid conduit system; and

FIG. 7 illustrates a portion of an example fluid conduit system including fluid conduits attached to opposite ends of the example transition fitting.

### DETAILED DESCRIPTION OF THE PREFERRED EMBODIMENT

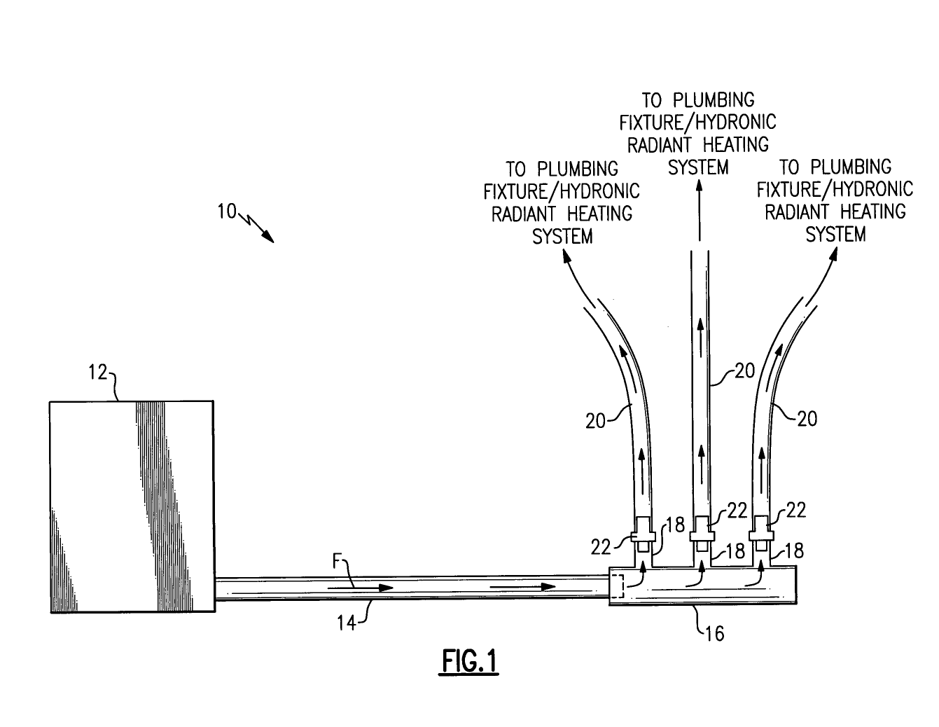

FIG. 1 schematically illustrates a fluid conduit system 10 for communicating a fluid F from a fluid main 12. In one example, the fluid F is water. In another example, the fluid F is natural gas. It should be understood that the fluid conduit system 10 may communicate any known fluid. The fluid main 12 may include a boiler, a gas main or any other fluid source.

The fluid F from fluid main 12 is communicated through a conduit 14 to a manifold circuit 16. For simplicity purposes, a single manifold circuit 16 is illustrated. However, a worker of ordinary skill in the art would understand that the fluid conduit system 10 could include any number of manifold circuits 16 for distributing the fluid F to a variety of locations within a commercial or residential building, for example.

The manifold circuit 16 includes a plurality of riser tubes 18 extending therefrom. The actual number of riser tubes 18 will vary depending upon design specific parameters, including the number of manifold circuits 16 utilized, and the amount of branches desired. A second conduit 20 is attached to each riser tube 18. A transition fitting 22 provides the connection between each riser tube 18 and the conduits 20. The transition fitting 22 may made from copper, brass, steel, plastic or any other suitable material.

In one example, the manifold circuit 16 and the riser tubes 18 are copper. In another example, the manifold circuit 16 and the riser tubes 18 are brass. The second conduit 20 is cross-linked polyethylene (PEX) tubing, in one example. In another example, the second conduit 20 is an auxiliary fitting, such as a valve, elbow or the like. It should be understood that the example transition fitting 22 may be used to provide a flow path connection between any fluid conduits.

The fluid F is communicated from the manifold circuit 16 into the riser tubes 18, through the conduits 20, and to a plurality of applications. In one example, the fluid conduit system 10 is a hydronic radiant heating system and the conduits 20 are distributed throughout a building or other structure to provide the radiant heating. For example, the conduits 20 may be distributed under the flooring in a building to provide heated flooring. In another example, the fluid conduit system 10 is a plumbing system, and the conduits 20 are distributed throughout a building to communicate the fluid F to a plurality of plumbing fixtures. It should be understood that the example fluid conduit system 10 may be used to communicate fluid to any type of system or any combination of systems.

FIG. 2 illustrates an example transition fitting 22 of the fluid conduit system 10. The transition fitting 22 is disposed about a longitudinal centerline axis A and includes a first end 24 and a second end 26 which is opposite from the first end 24. A first shoulder 28 is adjacent the first end 24 and a second shoulder 30 is adjacent the second end 26. A compression region 32 circumferentially extends between the first shoulder 28 and the second shoulder 30. The compression region 32 extends radially inwardly from said first shoulder and said second shoulder.

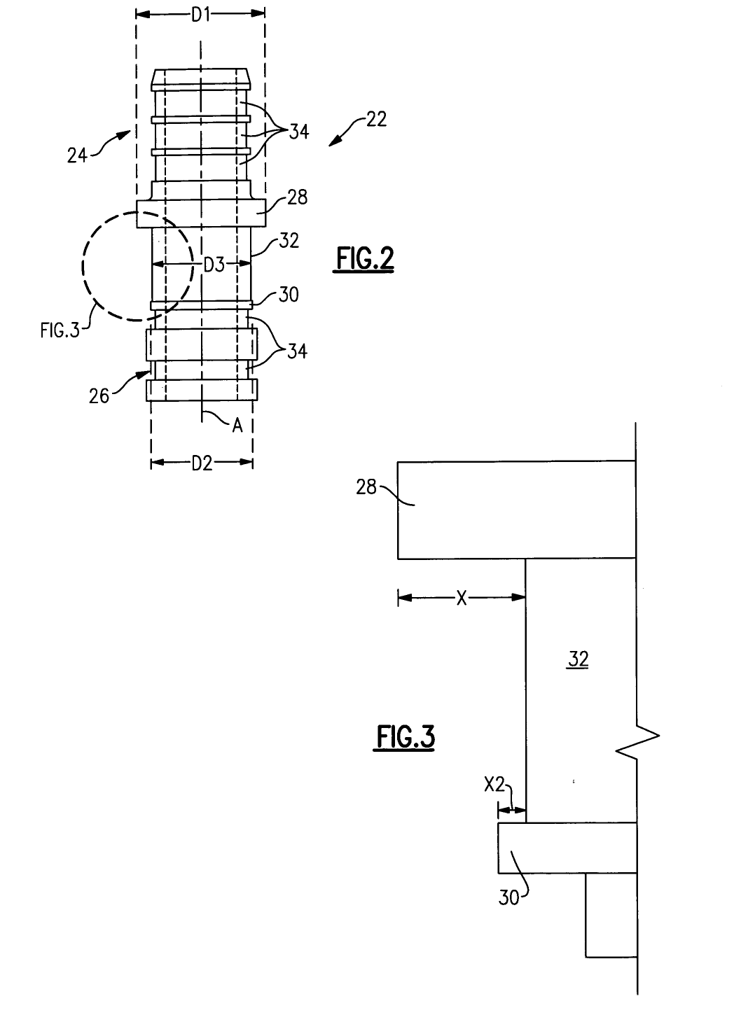

The first shoulder 28 extends past an outer diameter D3 of the compression region 32 a first distance X. The second shoulder 30 extends beyond the outer diameter of the compression region 32 a second distance X2 (See FIG. 3). In one example, the first distance X is greater than the second distance X2. That is, an outer diameter D1 of the first shoulder 28 is greater than an outer diameter D2 of the second shoulder 30 (See FIG. 2). It should be understood that the difference between the outer diameter D1 of the first shoulder 28 and the outer diameter D2 of the second shoulder 30 will vary depending upon design specific parameters, including but not limited to, the size of the transition fitting 22 and the flow requirements of the fluid conduit system 10. The first shoulder 28 and the second shoulder 30 prevent axial movement of the riser tubes 18 subsequent to being crimped to the transition fitting 22, as is further discussed below.

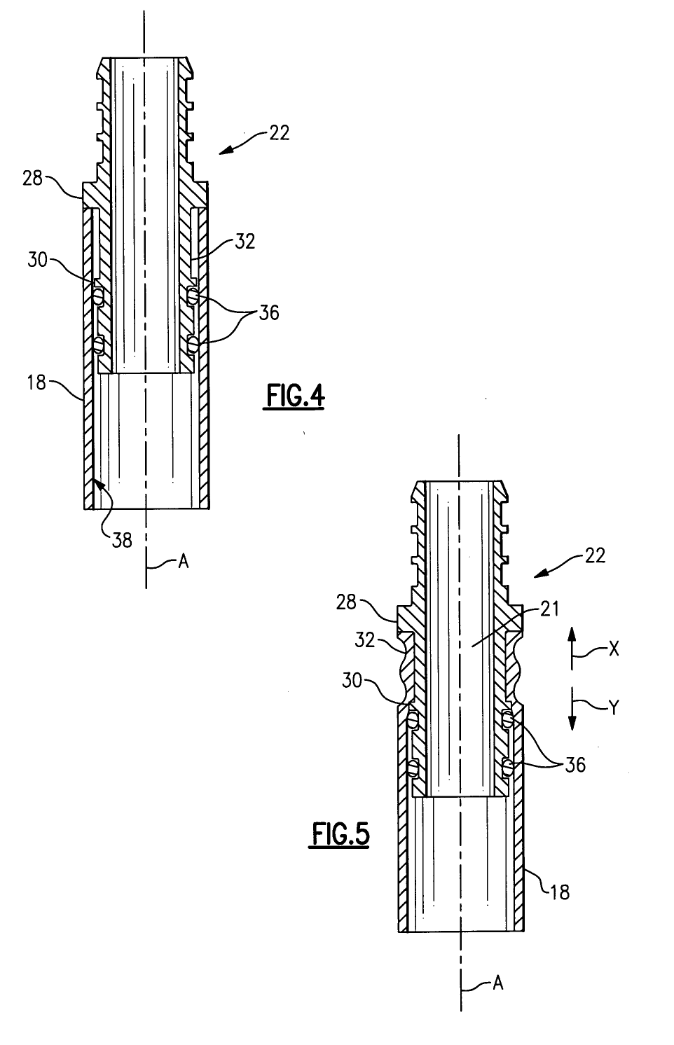

Each of the first end 24 and second end 26 of the transition fitting 22 include a plurality of grooves 34 which extend coaxially about the transition fitting 22. The grooves 34 may optionally receive seal members 36 for providing a leak-free connection between the transition fitting 22 and the riser tubes 18, for example. In one example, the seal members 36 include O-rings (See FIGS. 4 and 5).

FIG. 4 illustrates an example transition fitting 22 received within an inner diameter 38 of a riser tube 18. The transition fitting 22 is inserted into the riser tube 18 until at least a portion of the riser tube 18 contacts the first shoulder 28 of the transition fitting 22. That is, the first shoulder 28 acts as a stop to control the distance the transition fitting 22 is permitted to be inserted into the riser tube 18. In this example, the riser tube 18 is uncrimped to the transition fitting 22. Therefore, the riser tube 18 does not contact the transition fitting 22 at the compression region 32.

FIG. 5 illustrates the riser tube 18 crimped to the transition fitting 22 at the compression region 32. The riser tube 18 is deformed radially inwardly from the first shoulder and the second shoulder and is in direct contact with the compression region 32 along an entire outer circumference of the compression region 32 subsequent to the crimping operation. In the crimped position, the riser tube 18 is fixed in an axial direction along the longitudinal centerline axis A of the transition fitting 22. That is, a portion of the riser tube 18 contacts the first shoulder 28 in a first axial direction X, and a second portion of the riser tube 18 contacts the second shoulder 30 in response to axial movement in the Y direction. The outer diameter of the second shoulder 30 need be just large enough to provide an interference between a portion of the riser tube 18 and the transition fitting 22 as the riser tube is moved or pulled in the Y direction.

In the crimped position, the inner diameter 38 of the riser tube 18 contacts the seal members 36. Because the riser tube 18 is crimped adjacent to the seal members 36, rather than directly over the seal members 36, the transition fitting 22 is permitted to rotate about the longitudinal centerline axis A. The seal members 36 act as a cylinder to facilitate the rotation of the transition fitting 22 between the seal members 36 and the grooves 34. In addition, the seal members 36 are slightly depressed between the inner diameter 38 of the riser tube 18 and the grooves 34 of the transition fitting 22, even though the crimp joint is provided at the compression region 32 rather than directly over the seal members 36. Therefore, an adequate seal is maintained preventing the escape of the fluid F from along flow path 21 to between the transition fitting 22 and the riser tube 18.

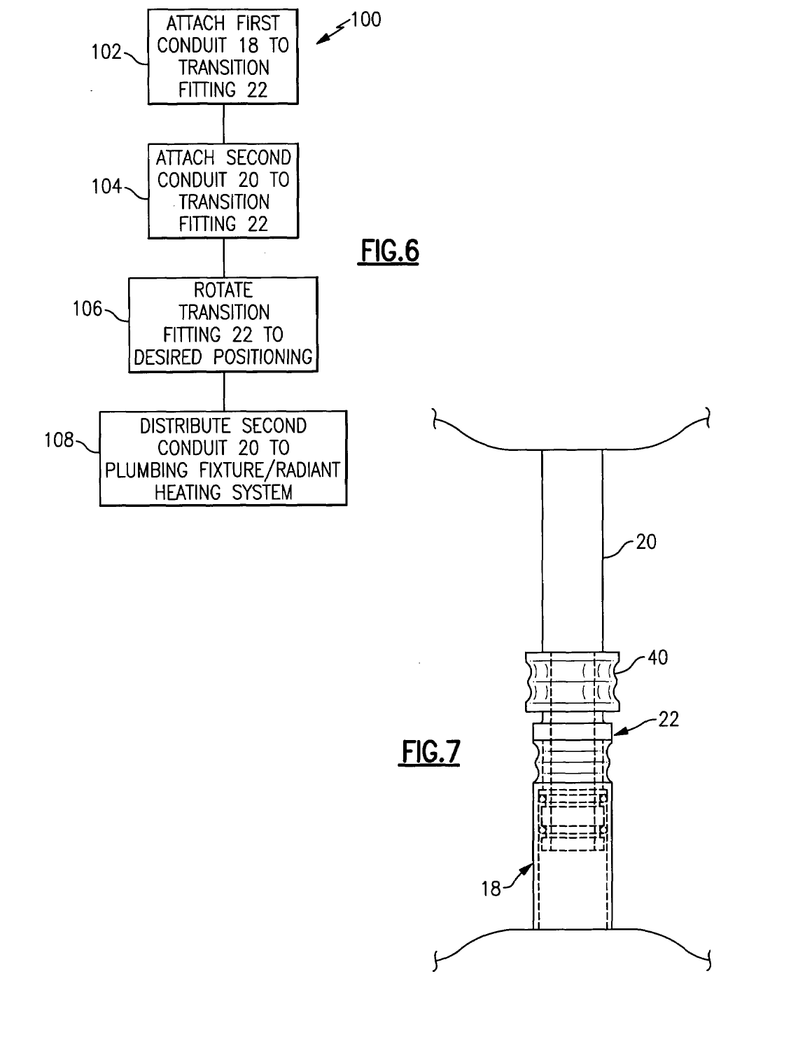

A method 100 for providing a fluid conduit system 10 is illustrated with respect to the block diagram shown in FIG. 6. At step block 102, each riser tube 18 of a manifold circuit 16 is connected to the second end 26 of a transition fitting 22. In one example, the riser tubes 18 are crimped to the transition fittings 22. A crimping tool is utilized to crimp the riser tubes 18 to the transition fittings 22 at the compression region 32. In one example, the crimping tool is the same tool utilized in ASTM standard F1807 to provide a connection between PEX tubing and a transition fitting. A worker of ordinary skill in the art would be able to select an appropriate crimping tool to perform the crimping operation.

At step block 104, a second conduit 20 is attached to the opposite end 24 of the transition fitting 22 from the riser tube 18. In one example, the second conduit 20 is PEX tubing. In another example, the second conduit 20 is an auxiliary fitting. A crimp ring 40 attaches the second conduit 20 to the transition fitting 22 (See FIG. 7).

The same crimping tool utilized at step block 102 is used to crimp the crimp ring 40 to the second conduit 20. The crimping operation compresses the crimp ring 40, thereby forcing the material of the second conduit 20 into the grooves 34 of the transition fitting 22. Advantageously, because the riser tube 18 is crimped about the compression region 32 of the transition fitting rather than directly over the seal members 36, a single crimping tool may be utilized to attach both the riser tube 18 and the second conduit 20 to the transition fitting 22. Therefore, the two crimping joints may be made in the same motion, thereby reducing the complexity of the joining process. It should be understood that step blocks 102 and 104 may be performed in a reverse order in which the second conduit 20 is attached to the transition fitting 22 initially, followed by the connection of the riser tube 18 to the transition fitting 22.

At step block 106, and subsequent to attaching both the riser tube 18 and the second conduit 20, the transition fitting 22 is rotated about its centerline longitudinal axis A. The transition fitting 22 is rotated to achieve a desired orientation of the second conduit 20. The transition fitting 22 provides flexibility during installation by permitting rotation of the transition fitting 22 subsequent to attachment of both the riser tube 18 and the second conduit 20.

For example, an installer may have a limited amount of space to provide a connection between the second conduit 20 and a plumbing fixture, for example. Therefore, by rotating the transition fitting 22, the installer may position the second conduit 20 at the most convenient orientation in order to provide the fluid connection to the plumbing fixture.

At step block 108, the second conduits 20 of the fluid conduit system 10 are distributed throughout a building or home. For example, the second conduits 20 may be connected to a plurality of plumbing devices, such as toilets, kitchen sinks and the like. In another example, the second conduits 20 are distributed to provide hydronic radiant heating. In yet another example, the second conduits 20 may be distributed to any combination of systems requiring a fluid connection.

The foregoing description shall be interpreted as illustrative and not in any limiting sense. A worker of ordinary skill in the art would recognize that certain modifications would come within the scope of this invention. For that reason, the follow claims should be studied to determine the true scope and content of this invention.

What is claimed is:

1. A transition fitting, comprising:
a fitting body having a first shoulder, a second shoulder and a compression region extending radially inwardly from said first shoulder and said second shoulder; and
at least one fluid conduit attached to said fitting body about said compression region, said at least one fluid conduit deformed radially inwardly from said first shoulder and said second shoulder to secure said fitting body in an axial direction along a longitudinal centerline axis of said fitting body, wherein said fitting body is rotatable about said longitudinal centerline axis of said fitting body.

2. The transition fitting as recited in claim 1, wherein said fitting body includes a first end and a second end opposite of said first end, wherein at least one of said first end and said second end include a plurality of grooves that receive a plurality of seal members.

3. The transition fitting as recited in claim 2, wherein said plurality of seal members are positioned between said at least one fluid conduit and said plurality of grooves.

4. The transition fitting as recited in claim 1, wherein said at least one fluid conduit contacts said first shoulder in a first axial direction and contacts said second shoulder in a second axial direction.

5. The transition fitting as recited in claim 1, wherein said transition fitting is formed of at least one of copper, brass, steel and plastic.

6. The transition fitting as recited in claim 1, wherein said at least one fluid conduit is deformed about said compression region of said fitting body along an outer circumference of said compression region.

7. The transition fitting as recited in claim 1, wherein said first shoulder includes a first outer diameter and said second shoulder includes a second outer diameter, wherein said first outer diameter is greater than said second outer diameter.

8. A fluid conduit system, comprising:
a fluid main;
a manifold circuit in communication with said fluid main and having at least one riser tube extending from said manifold circuit;
a fluid conduit in communication with said at least one riser tube;
a transition fitting positioned between said at least one riser tube and said fluid conduit, wherein each of said at least one riser tube and said fluid conduit are attached to opposite ends of said transition fitting, said transition fitting being circumferentially rotatable about a longitudinal centerline axis of said transition fitting.

9. The system as recited in claim 8, wherein said fluid conduit system is part of a hydronic radiant heating system.

10. The system as recited in claim 8, wherein said fluid conduit system is part of a plumbing system.

11. The system as recited in claim 8, wherein said at least one riser tube comprises a first material and said second fluid conduit comprises a second material, wherein said first material is different than said second material.

12. The system as recited in claim 11, wherein said first material includes copper and said second material includes cross linked polyethylene (PEX).

13. The system as recited in claim 8, wherein said transition fitting includes a first shoulder, a second shoulder and a compression region extending radially inwardly from said first shoulder and said second shoulder, wherein said at least one riser tube is deformed radially inwardly from said first shoulder and said second shoulder to secure said at least one riser tube in an axial direction, wherein said at least one riser tube directly contacts said compression region of said fitting body along an outer circumference of said compression region.

14. The system as recited in claim 8, wherein said transition fitting defines a flow path along said longitudinal centerline axis to communicate a fluid between said at least one riser tube and said fluid conduit.

15. The system as recited in claim 8, comprising a crimp ring that attaches said fluid conduit to said transition fitting.

16. A method of providing a fluid conduit system, comprising the steps of:
(a) connecting a first fluid conduit to a transition fitting;
(b) connecting a second fluid conduit to the transition fitting at an opposite end of the transition fitting from the first fluid conduit; and
(c) rotating the transition fitting about its longitudinal centerline axis subsequent to said steps (a) and (b) to position one of the first fluid conduit and the second fluid conduit at a desired orientation.

17. The method as recited in claim 16, wherein each of said step (a) and said step (b) comprises:
crimping each of the first fluid conduit and the second fluid conduit to the transition fitting with the same crimping tool.

18. The method as recited in claim 16, comprising the step of:
(d) repeating said steps (a) through (c) for each branch included on a manifold circuit of a plumbing system; and
(e) distributing at least one of the first fluid conduits and the second fluid conduits to a plurality of plumbing fixtures.

19. The method as recited in claim 16, comprising the step of:
(d) repeating said steps (a) through (c) for each branch included on a manifold circuit of a hydronic radiant heating system; and
(e) distributing at least one of the first fluid conduits and the second fluid conduits throughout a building.

20. The method a recited in claim 16, wherein the transition fitting includes a first shoulder, a second shoulder and a compression region between the first shoulder and the second shoulder, wherein at least one of said step (a) and said step (b) includes the step of:
deforming at least one of the first fluid conduit and the second fluid conduit radially inwardly from the first shoulder and the second shoulder about an outer circumference of the compression region.
